(19) United States
(12) Patent Application Publication
(10) Pub. No.: US 2009/0146065 A1
(43) Pub. Date: Jun. 11, 2009

(54) SCINTILLATOR MATERIALS BASED ON LANTHANIDE SILICATES OR LANTHANIDE PHOSPHATES, AND RELATED METHODS AND ARTICLES

(75) Inventors: Alok Mani Srivastava, Niskayuna, NY (US); Holly Ann Comanzo, Niskayuna, NY (US); James Scott Vartuli, Rexford, NY (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: GENERAL ELECTRIC COMPANY, SCHENECTADY, NY (US)

(21) Appl. No.: 11/952,650

(22) Filed: Dec. 7, 2007

(51) Int. Cl. G01T 1/20

(52) U.S. Cl. 250/361 R

(57) ABSTRACT

A scintillator composition is described. The composition includes a matrix material in the form of a host lattice characterized by a 4f5d→4f optical transition under activation. The matrix material is based on certain lithium-lanthanide silicate compounds or alkali-lanthanide phosphate compounds. The composition also includes a praseodymium (Pr) activator for the matrix material. Radiation detectors which include crystal scintillators are also part of the present invention, as are methods for detecting high-energy radiation, using these devices.

### BACKGROUND OF THE INVENTION

The invention described herein relates generally to materials for detecting high energy radiation, i.e., luminescent materials. In some specific embodiments, the invention is directed to scintillator compositions which are especially useful for detecting gamma-rays and X-rays under a variety of conditions.

When high energy radiation contacts a scintillating crystal, a large number of electron-hole pairs are formed within the crystal. Recombination of these electron-hole pairs will release low levels of energy, e.g., several eV. The energy can be emitted directly from the recombination in the form of light, or can be transferred to a light-emitting ion center which then emits a specific wavelength of light. This low-energy emission can be detected by some form of light-detection means, e.g., a photodetector. The photodetector produces an electrical signal proportional to the number of light pulses received, and to their intensity.

Scintillators have been found to be useful for applications in chemistry, physics, geology, and medicine. Specific examples of the applications include positron emission tomography (PET) devices; well-logging for the oil and gas industry, and various digital imaging applications. Scintillators are also being investigated for use in detectors for security devices, e.g., detectors for radiation sources which may indicate the presence of radioactive materials in cargo containers.

In each exemplary application described above, the composition of the scintillator is critical to device performance. The scintillator must be responsive to X-ray and gamma ray excitation. Moreover, the scintillator should possess a number of characteristics which enhance radiation detection. For example, most scintillator materials must possess one or more attributes such as high light output, short decay time, high “stopping power”, and acceptable energy resolution. (Other properties can also be very significant, depending on how the scintillator is used, as mentioned below).

Various scintillator materials which possess most or all of these properties have been in use over the years. Examples include thallium-activated sodium iodide (NaI(Tl)); bismuth germanate (BGO); cerium-doped gadolinium orthosilicate (GSO); cerium-doped lutetium orthosilicate (LSO); and cerium-activated lanthanide-halide compounds. Each of these materials have properties which are very suitable for certain applications. However, many of them also have some drawbacks. The common problems are low light yield, physical weakness, and the inability to produce large-size, high quality single crystals. Other drawbacks are also present. For example, the thallium-activated materials are very hygroscopic, and can also produce a large and persistent after-glow, which can interfere with scintillator function. Moreover, the BGO materials frequently have a slow decay time. On the other hand, the LSO materials are expensive, and may also contain radioactive lutetium isotopes which can also interfere with scintillator function.

As a general notion, those interested in obtaining the optimum scintillator composition for a radiation detector have been able to review the various attributes set forth above, and thereby select the best composition for a particular device. (As an illustration, scintillator compositions for well-logging applications must be able to function at high temperatures, while scintillators for PET devices must often exhibit high stopping power). However, the required overall performance level for most scintillators continues to rise with the increasing sophistication and diversity of all radiation detectors. For example, there is a continuing desire for PET scintillators with decay times faster than those typically present in this application, e.g., faster than about 30 ns.

It should thus be apparent that new scintillator materials would be of considerable interest, if they could satisfy the ever-increasing demands for commercial and industrial use. The materials should exhibit excellent light output and relatively fast decay times. They should also possess other desirable properties, such as good energy resolution characteristics, especially in the case of gamma rays. Furthermore, they should be capable of being produced efficiently, at reasonable cost and acceptable crystal size.

### BRIEF DESCRIPTION OF THE INVENTION

One embodiment of the present invention is directed to a scintillator composition comprising the following, and any reaction products thereof:

(a) a matrix material in the form of a host lattice characterized by a 4f5d→4f optical transition under activation, comprising:
(i) a lithium-lanthanide silicate compound of the formula

LiLnSiO₄,
or
(ii) an alkali-lanthanide phosphate compound of the formula

A₃Ln(PO₄)₂,

wherein Ln is at least one lanthanide element selected from the group consisting of lanthanum (La), yttrium (Y), gadolinium (Gd), praseodymium (Pr), and lutetium (Lu); and A is at least one alkali element selected from the group consisting of cesium (Cs), rubidium (Rb), potassium (K), and sodium (Na); and

(b) a praseodymium (Pr) activator for the matrix material.

Another aspect of the invention is directed to a radiation detector for detecting high-energy radiation, comprising:
(A) a crystal scintillator based on the composition set forth above, and further described in the remainder of the specification; and
(B) a photodetector optically coupled to the scintillator, so as to be capable of producing an electrical signal in response to the emission of a light pulse produced by the scintillator.

A method for detecting high-energy radiation with a scintillation detector constitutes still another embodiment of this invention. The method comprises the steps of:

(A) receiving radiation by a scintillator crystal as described herein, so as to produce photons which are characteristic of the radiation; and

(B) detecting the photons with a photon detector coupled to the scintillator crystal.

Other features and advantages will be apparent from a review of the following detailed description of the invention. Moreover, as used throughout this disclosure, the terms “a” and “an” do not denote a limitation of quantity, but rather denote the presence of at least one of the referenced items. The suffix “(s)” as used herein is intended to include both the singular and the plural of the term that it modifies, thereby including one or more of that term (e.g., the “lanthanide” or “element” can include one or more lanthanides or elements, respectively).

### BRIEF DESCRIPTION OF THE DRAWINGS

FIG. 1 is a graph of emission spectra (under UV and X-ray excitation), for a scintillator composition according to one embodiment of the present invention.

FIG. 2 is a graph of the emission spectrum (under UV and X-ray excitation), for a scintillator composition according to another embodiment of the present invention.

### DETAILED DESCRIPTION OF THE INVENTION

As mentioned above, the scintillator comprises a matrix material in the form of a host lattice. According to the present invention, the host lattice is characterized by a 4f5d→4f optical transition under activation. The matrix material comprises a lithium-lanthanide silicate compound or an alkali-lanthanide phosphate compound.

The lithium-lanthanide silicate compound is based on the formula LiLnSiO₄. In this formula, Ln represents at least one lanthanide element selected from the group consisting of lanthanum (La), yttrium (Y), gadolinium (Gd), praseodymium (Pr), and lutetium (Lu). (For the purpose of this disclosure, yttrium is also considered to be a part of the lanthanide family. Those skilled in the art understand that yttrium is closely associated with the rare earth group). In some embodiments, preferred lanthanides within this group are La and Lu (for LiLaSiO₄ and LiLuSiO₄, respectively). Lutetium is often the most preferred lanthanide in the case of PET devices.

The alkali-lanthanide phosphate compound is based on the formula A₃Ln(PO₄)₂. In this formula, Ln represents at least one lanthanide element, as described previously. As in the case of the silicate compounds, a preferred group of lanthanides often comprises La and Lu (for A₃La(PO₄)₂ and A₃Lu(PO₄)₂, respectively), with Lu sometimes being most preferred. “A” represents at least one alkali element selected from the group consisting of cesium (Cs), rubidium (Rb), potassium (K), and sodium (Na). (It should be understood that combinations of alkali metals are also possible, e.g., combinations of K and Na in various proportions). In some embodiments, potassium is the preferred alkali metal. However, in other cases, cesium or rubidium is preferred. Non-limiting examples of suitable alkali-lanthanide phosphate compounds include K₃Lu(PO₄)₂, K₂CsLu(PO₄)₂, K₂RbLu(PO₄)₂, Cs₃Lu(PO₄)₂, and Rb₃Lu(PO₄)₂.

In some embodiments, e.g., in the case of down-hole drilling applications, it is often preferable that the scintillator composition exhibit relatively low natural radiation characteristics. (As alluded to previously, radioactive isotopes in the scintillator can undesirably interfere with its function). In that instance, phosphate-based scintillator compounds comprising sodium and a lanthanide (and conforming to the A₃Ln(PO₄)₂ formula noted above) are sometimes preferred. Non-limiting examples of such compounds include Na₃Y(PO₄)₂, Na₃La(PO₄)₂, Na₃Gd(PO₄)₂, Na₃Lu(PO₄)₂, and various combinations thereof.

An activator or “dopant” for the matrix material is also present in these compositions. For most embodiments, the activator must be praseodymium. The present inventors have discovered that the luminescence of the Pr⁺³ ion in the ultraviolet region corresponds to the 4f5d→4f optical transition, when the LiLnSiO₄ or A₃Ln(PO₄)₂ matrices are employed. This optical transition is highly preferred for the scintillators of the present invention, in terms of luminescence efficiency and decay time.

The appropriate level of activator will depend on various factors, such as the particular silicate or phosphate compound present in the matrix; the desired emission properties and decay time; and the type of detection device into which the scintillator is being incorporated. Usually, the activator is employed at a level in the range of about 0.1 mole % to about 20 mole %, based on total moles of activator and matrix material. In many preferred embodiments, the amount of activator is in the range of about 1 mole % to about 10 mole %.

In some embodiments, the praseodymium activator can be part of the matrix material. In other words, these compositions might be characterized as “self-activating”, with substantially all of the lanthanide component being praseodymium. Thus, the present invention also includes scintillator compositions which comprise compounds such as LiPrSiO₄ and A₃Pr(PO₄)₂, wherein “A” is as defined previously, and wherein Pr is present at the levels noted above, i.e., about 0.1-20 mole %.

In the case of both the phosphate and the silicate scintillator compounds, the relative proportions of phosphate/silicate to lanthanide and alkali metal constituents can vary considerably. Usually, the proportions will depend on stoichiometric considerations, such as valence, atomic weight, chemical bonding, coordination number, and the like. However, variations from stoichiometric proportions are possible, e.g., variations by as much 10 atomic % or more in some instances.

In some embodiments (though not all), the matrix material may further comprise bismuth. The presence of bismuth can enhance various properties, like stopping power. The amount of bismuth (when present) can vary to some extent. Usually, bismuth would be present at a level of about 1 mole % to about 40 mole % of the total molar weight of the matrix material (i.e., component (a)), including the bismuth itself. In preferred embodiments, the level of bismuth is about 5 mole % to about 20 mole %.

The scintillator composition may be prepared and used in various forms. In some preferred embodiments, the composition is in monocrystalline (i.e., “single crystal”) form. Monocrystalline scintillator crystals have a greater tendency for transparency. They are especially useful for high-energy radiation detectors, e.g., those used for gamma rays. The scintillator composition can be used in other forms as well, depending on its intended end use. For example, it can be in powder form.

It should also be understood that the scintillator compositions may contain small amounts of impurities, as described, for example, in two publications, WO 01/60944 A2 and WO 01/60945 A2 (incorporated herein by reference). These impurities usually originate with the starting materials, and typically constitute less than about 0.1% by weight of the scintillator composition. Very often, they constitute less than about 0.01% by weight of the composition. The composition may also include parasitic additives, whose volume percentage is usually less than about 1%. Moreover, minor amounts of other materials may be purposefully included in the scintillator compositions.

A variety of techniques can be used for the preparation of the scintillator compositions. (It should be understood that the compositions may also contain a variety of reaction products of these techniques). Usually, a suitable powder containing the desired materials in the correct proportions is first prepared, followed by such operations as calcination, die forming, sintering, and/or hot isostatic pressing. The powder can be prepared by mixing various forms of the reactants (e.g., salts, halides, or mixtures thereof). In some cases, individual constituents are used in combined form. (They may be commercially available in that form, for example). As an illustration, various halides of the alkali metals could be used. Non-limiting examples include compounds such as cesium chloride, potassium bromide, cesium bromide, cesium iodide, and the like.

The mixing of the reactants can be carried out by any suitable techniques which ensure thorough, uniform blending. For example, mixing can be carried out in an agate mortar and pestle. Alternatively, a blender or pulverization apparatus can be used, such as a ball mill, a bowl mill, a hammer mill, or a jet mill. Conventional precautions usually must be taken to prevent the introduction of any air or moisture during mixing. The mixture can also contain various additives, such as fluxing compounds and binders. Depending on compatibility and/or solubility, various liquids can sometimes be used as a vehicle during milling. Suitable milling media should be used, e.g., material that would not be contaminating to the scintillator, since such contamination could reduce its light-emitting capability.

After being blended, the mixture can then be fired under temperature and time conditions sufficient to convert the mixture into a solid solution. These conditions will depend in part on the specific type of matrix material and activator being used. The mixture is usually contained in a sealed vessel (e.g., a tube or crucible made of quartz or silver) during firing, so that none of the constituents are lost to the atmosphere). Usually, firing will be carried out in a furnace, at a temperature in the range of about 500° C. to about 1500° C. The firing time will typically range from about 15 minutes to about 10 hours. Firing is usually carried out in an atmosphere free of oxygen and moisture, e.g., in a vacuum, or using an inert gas such as nitrogen, helium, neon, argon, krypton, and xenon. After firing is complete, the resulting material can be pulverized, to put the scintillator into powder form. Conventional techniques can then be used to process the powder into radiation detector elements.

In the case of single crystal materials, preparation techniques are also well-known in the art. A non-limiting, exemplary reference is “Luminescent Materials”, by G. Blasse et al, Springer-Verlag (1994). Usually, the appropriate reactants are melted at a temperature sufficient to form a congruent, molten composition. The melting temperature will depend on the identity of the reactants themselves, but is usually in the range of about 650° C. to about 1100° C.

A variety of techniques can be employed to prepare a single crystal of the scintillator material from a molten composition. They are described in many references, such as U.S. Pat. No. 6,437,336 (Pauwels et al); U.S. Pat. No. 5,322,588 (Habu et al); U.S. Pat. No. 4,579,622 (Caporaso et al); “Crystal Growth Processes”, by J. C. Brice, Blackie & Son Ltd (1986); and the “Encyclopedia Americana”, Volume 8, Grolier Incorporated (1981), pages 286-293. These descriptions are incorporated herein by reference. Non-limiting examples of the crystal-growing techniques are the Bridgman-Stockbarger method; the Czochralski method, the zone-melting method (or “floating zone” method); the temperature gradient method (thermal gradient technology); hydrothermal crystal growth processes, and flux growth processes, such as the top-seeded solution growth (TSSG) techniques. Those skilled in the art are familiar with the necessary details regarding each of these processes.

U.S. Pat. No. 6,585,913 (Lyons et al; incorporated herein by reference) provides some useful information for one method of producing a scintillator in single crystal form. In this method, a seed crystal of the desired composition (described above) is introduced into a saturated solution. The solution is contained in a suitable crucible, and contains appropriate precursors for the scintillator material. The new crystalline material is allowed to grow and add to the single crystal, using one of the growing techniques mentioned above. The size of the crystal will depend in part on its desired end use, e.g., the type of radiation detector in which it will be incorporated.

The present invention includes another embodiment, i.e., a method for detecting high-energy radiation with a scintillation detector. The detector includes one or more crystals, formed from the scintillator composition described herein. Scintillation detectors are well-known in the art, and need not be described in detail here. Several references (of many) which discuss such devices are U.S. Pat. Nos. 6,585,913 and 6,437,336, mentioned above, and U.S. Pat. No. 6,624,420 (Chai et al), which is also incorporated herein by reference. In general, the scintillator crystals in these devices receive radiation from a source being investigated, and produce photons which are characteristic of the radiation. The photons are detected with some type of photodetector (“photon detector”). (The photodetector is connected to the scintillator crystal by conventional electronic and mechanical attachment systems).

The photodetector can be a variety of devices, all well-known in the art. Non-limiting examples include photomultiplier tubes, photodiodes, CCD sensors, and image intensifiers. Choice of a particular photodetector will depend in part on the type of radiation detector being fabricated, and on its intended use.

The radiation detectors themselves, which include the scintillator and the photodetector, can be connected to a variety of tools and devices, as mentioned previously. Non-limiting examples include well-logging tools and nuclear medicine devices (e.g., PET). The radiation detectors may also be connected to digital imaging equipment, e.g., pixilated flat panel devices. Moreover, the scintillator may serve as a component of a screen scintillator. For example, powdered scintillator material could be formed into a relatively flat plate which is attached to a film, e.g., photographic film. High energy radiation, e.g., X-rays, originating from some source, would contact the scintillator and be converted into light photons which are developed on the film. Furthermore, the radiation detectors may also be used for security devices. For example, they could be used to detect the presence of radioactive materials in cargo containers.

Several of the specific end use applications can be described here in more detail, although many of the relevant details are known to those skilled in the art. Medical imaging equipment represents an important application for these radiation detectors. Examples include the PET devices mentioned above, as well as single photon emission computerized tomography (SPECT) devices. (SPECT imaging is based on the detection of individual gamma rays emitted from the body, while PET imaging is based on the detection of gamma-ray pairs that are emitted in coincidence).

The technology for operably connecting the radiation detector (containing the scintillator) to a PET device is well-known in the art. The general concepts are described in many references, such as U.S. Pat. No. 6,624,422 (Williams et al), incorporated herein by reference. In brief, a radiopharmaceutical is usually injected into a patient, and becomes concentrated within an organ of interest. Radionuclides from the compound decay and emit positrons. When the positrons encounter electrons, they are annihilated and converted into photons, or gamma rays. The PET scanner can locate these “annihilations” in three dimensions, and thereby reconstruct the shape of the organ of interest for observation. The detector modules in the scanner usually include a number of “detector blocks”, along with the associated circuitry. Each detector block may contain an array of the scintillator crystals, in a specified arrangement, along with photomultiplier tubes. As in the case of well-logging devices, many variations on PET devices are possible. Details regarding SPECT devices are also known in the art; e.g., as described in U.S. Pat. No. 6,642,523 (Wainer), which is incorporated herein by reference.

Well-logging devices represent another important application for these radiation detectors. The technology for operably connecting the radiation detector to a well-logging tube is well-understood. The general concepts are described in U.S. Pat. No. 5,869,836 (Linden et al), which is incorporated herein by reference. The crystal package containing the scintillator usually includes an optical window at one end of the enclosure-casing. The window permits radiation-induced scintillation light to pass out of the crystal package for measurement by the light-sensing device (e.g., the photomultiplier tube), which is coupled to the package. The light-sensing device converts the light photons emitted from the crystal into electrical pulses that are shaped and digitized by the associated electronics. By this general process, gamma rays can be detected, which in turn provides an analysis of the rock strata surrounding the drilling bore holes. It should be emphasized, however, that many variations of well-logging devices are possible.

The light output of the scintillator is critical for well-logging, PET, and SPECT technologies. The present invention can provide scintillator materials which possess the desired light output for demanding applications of the technologies. Moreover, it is possible that the crystals can simultaneously exhibit some of the other important properties noted above, e.g., short decay time, high “stopping power”, and acceptable energy resolution. Furthermore, the scintillator materials can be manufactured economically. They can also be employed in a variety of other devices which require radiation detection.

### EXAMPLES

These examples are illustrative, and should not be construed to be any sort of limitation on the scope of the claimed invention.

### Example 1

A set of samples of a praseodymium-activated scintillator composition was prepared in this example. The matrix portion of the composition had the formula LiLuSiO₄, while the level of praseodymium activator was varied (1%, 2%, 5%, and 10%). An illustrative preparation is described, for 5 grams of LiLu_{0.99}Pr_{0.01}SiO₄. In this preparation, 0.7426 grams of Li₂CO₃ (10 mole % excess), 3.5990 grams of Lu₂O₃, 0.0311 grams of Pr₆O₁₁, and 1.2522 grams of silicic acid were mixed with 2 mole % LiF (flux). The mixture was heated to 800° C. for two hours in a slightly-reducing atmosphere of 0.5% H₂. The resulting sample was further ground and reheated at 1000° C. for five hours, under the same atmosphere. All grinding steps were carried out in air. (Component proportions were adjusted to provide the samples below). The nominal formula for each of the four compositions, after the re-heating step, was as follows:

LiLu_{0.99}Pr_{0.01}SiO₄; (1% activator)

LiLu_{0.98}Pr_{0.02}SiO₄; (2% activator)

LiLu_{0.95}Pr_{0.05}SiO₄; (5% activator); and

LiLu_{0.90}Pr_{0.10}SiO₄ (10% activator).

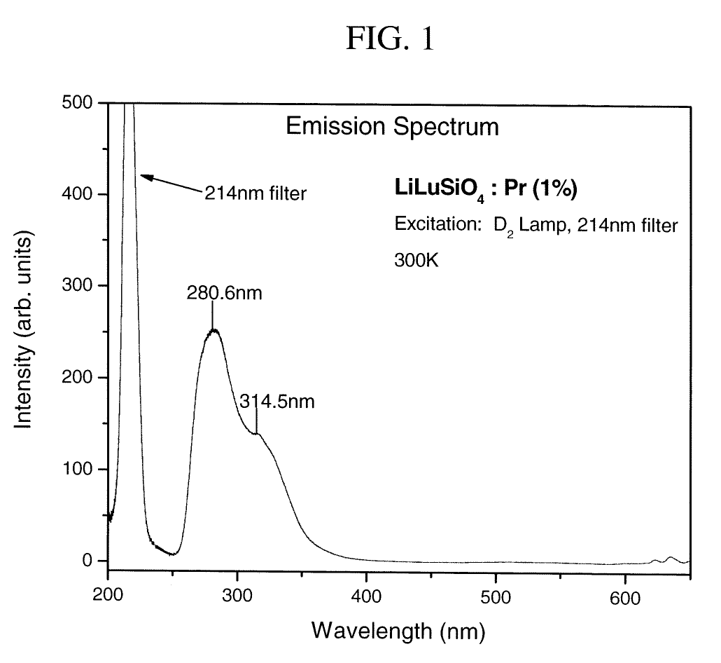

The emission spectrum for the sample was determined under UV and X-ray excitation, using an optical spectrometer. FIG. 1 is a plot of wavelength (nm) as a function of intensity (arbitrary units), for one of the samples (1% activator). The peak emission wavelength for the sample was about 281 nm. (The peak emission may vary for each particular silicate compound). The emission under UV and X-ray excitation was characteristic of the praseodymium ion in this matrix, exhibiting a 4f5d→4f optical transition. It is expected that the emission under gamma ray excitation would have a similar characteristic, so that the samples would be very useful in devices employed to detect gamma rays. Moreover, the samples containing other levels of the activator (2%, 5%, and 10%) had similar characteristics.

### Example 2

In this example, a phosphate-based scintillator material (5 grams) was prepared according to the present invention. The matrix portion of the composition had the formula K₃Lu(PO₄)₂, while the level of praseodymium activator was 5%. In this preparation, 2.292 grams of K₂CO₃ (10 mole % excess), 1.9669 grams of Lu₂O₃, 0.0886 grams of Pr₆O₁₁, and 2.8858 grams of DAP (diammonium hydrogen phosphate; 10 mole % excess) were mixed and heated to 600° C. for two hours in air. The product was re-ground and reheated to 950° C. for five hours, in a slightly-reducing atmosphere of 0.5% H₂. All of the grinding was carried out in air.

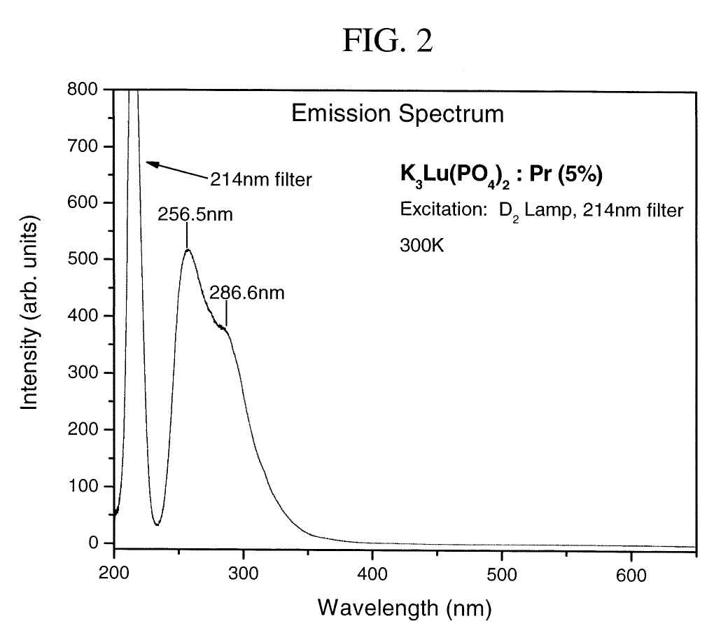

The emission spectrum for this sample was also determined under UV and X-ray excitation, using an optical spectrometer. FIG. 2 is a plot of wavelength (nm) as a function of intensity (arbitrary units) for sample. The peak emission wavelength for the sample was about 257 nm. (The peak emission may vary for each particular phosphate compound). As in the case of the silicate compounds of Example 1, the emission under UV and X-ray excitation was characteristic of the praseodymium ion in this matrix, exhibiting a 4f5d→4f optical transition. It is also expected that the emission under gamma ray excitation would have a similar characteristic, so that these samples would be very useful in devices employed to detect gamma rays.

While this invention has been described in detail, with reference to specific embodiments, it will be apparent to those of ordinary skill in this area of technology that other modifications of this invention (beyond those specifically described herein) may be made, without departing from the spirit of the invention. Accordingly, the modifications contemplated by those skilled in the art should be considered to be within the scope of this invention. Furthermore, all of the patents, patent publications, articles, texts, and other references mentioned above are incorporated herein by reference.

What is claimed:

1. A scintillator composition, comprising the following, and any reaction products thereof:
(a) a matrix material in the form of a host lattice characterized by a 4f5d→4f optical transition under activation, comprising:
(i) a lithium-lanthanide silicate compound of the formula
LiLnSiO₄,
or
(ii) an alkali-lanthanide phosphate compound of the formula A₃Ln(PO₄)₂,
wherein Ln is at least one lanthanide element selected from the group consisting of lanthanum (La), yttrium (Y), gadolinium (Gd), lutetium (Lu), and praseodymium (Pr); and A is at least one alkali element selected from the group consisting of cesium (Cs), rubidium (Rb), potassium (K), and sodium (Na); and
(b) a praseodymium activator for the matrix material.

2. The scintillator composition of claim 1, wherein the lanthanide for (i) or (ii) is La or Lu.

3. The scintillator composition of claim 1, wherein A in component a(ii) is K or Rb.

4. The scintillator composition of claim 1, wherein A comprises a mixture of alkali elements.

5. The scintillator composition of claim 1, wherein the lithium-lanthanide silicate compound is LiLuSiO₄, or LiLaSiO₄.

6. The scintillator composition of claim 1, wherein the alkali-lanthanide phosphate compound is selected from the group consisting of K₃Lu(PO₄)₂, K₂CsLu(PO₄)₂, K₂RbLu(PO₄)₂, Cs₃Lu(PO₄)₂, Rb₃Lu(PO₄)₂. Na₃Y(PO₄)₂, Na₃La(PO₄)₂, Na₃Gd(PO₄)₂, and Na₃Lu(PO₄)₂.

7. The scintillator composition of claim 1, wherein the praseodymium activator is present at a level in the range of about 0.1 mole % to about 20 mole %, based on total moles of activator and matrix material.

8. The scintillator composition of claim 7, wherein the praseodymium activator is present at a level in the range of about 1 mole % to about 10 mole %, based on total moles of activator and matrix material.

9. The scintillator composition of claim 1, wherein the matrix material of component (a) comprises the praseodymium activator of component (b).

10. A scintillator composition comprising at least one material selected from the group consisting of LiPrSiO₄ and A₃Pr(PO₄)₂, wherein “A” is at least one alkali element selected from the group consisting of cesium (Cs), rubidium (Rb), potassium (K), and sodium (Na).

11. A radiation detector for detecting high-energy radiation, comprising:
(A) a crystal scintillator which comprises the following composition, and any reaction products thereof:
(a) a matrix material in the form of a host lattice characterized by a 4f5d→4f optical transition under activation, comprising:
(i) a lithium-lanthanide silicate compound of the formula
LiLnSiO₄,
or
(ii) an alkali-lanthanide phosphate compound of the formula
A₃Ln(PO₄)₂,
wherein Ln is at least one lanthanide element selected from the group consisting of lanthanum (La), yttrium (Y), gadolinium (Gd), lutetium (Lu), and praseodymium (Pr); and A is at least one alkali element selected from the group consisting of cesium (Cs), rubidium (Rb), potassium (K), and sodium (Na); and
(b) a praseodymium (Pr) activator for the matrix material; and
(B) a photodetector optically coupled to the scintillator, so as to be capable of producing an electrical signal in response to the emission of a light pulse produced by the scintillator.

12. The radiation detector of claim 11, wherein the lithium-lanthanide silicate compound is LiLuSiO₄, or LiLaSiO₄.

13. The radiation detector of claim 11, wherein the lanthanide for a(i) or a(ii) is La or Lu.

14. The radiation detector of claim 11, wherein A in component a(ii) of the scintillator is K or Rb.

15. The radiation detector of claim 11, wherein the matrix material of component (a) comprises the praseodymium activator of component (b).

16. The radiation detector of claim 11, wherein the matrix material further comprises bismuth (Bi)

17. The radiation detector of claim 11, wherein the photodetector is at least one device selected from the group consisting of a photomultiplier tube, a photodiode, a CCD sensor, and an image intensifier.

18. The radiation detector of claim 11, operably connected to a nuclear medicine apparatus.

19. The radiation detector of claim 18, wherein the nuclear medicine apparatus comprises a positron emission tomography (PET) device or a single photon emission computerized tomography (SPECT) device.

20. The radiation detector of claim 11, operably connected to a device for detecting the presence of radioactive materials in cargo containers.

21. A method for detecting high-energy radiation with a scintillation detector, comprising the steps of:
(A) receiving radiation by a scintillator crystal, so as to produce photons which are characteristic of the radiation; and
(B) detecting the photons with a photon detector coupled to the scintillator crystal;
wherein the scintillator crystal is formed of a composition comprising the following, and any reaction products thereof:
(a) a matrix material in the form of a host lattice characterized by a 4f5d→4f optical transition under activation, comprising:
(i) a lithium-lanthanide silicate compound of the formula
LiLnSiO₄,
or
(ii) an alkali-lanthanide phosphate compound of the formula
A₃Ln(PO₄)₂,
wherein Ln is at least one lanthanide element selected from the group consisting of lanthanum (La), yttrium (Y), gadolinium (Gd), lutetium (Lu), and praseodymium (Pr); and A is at least one alkali element selected from the group consisting of cesium (Cs), rubidium (Rb), potassium (K), and sodium (Na); and
(b) a praseodymium (Pr) activator for the matrix material.

22. The method of claim 21, wherein the matrix material of component (a) comprises the praseodymium activator of component (b).

23. The method of claim 21, wherein the scintillation detector is operably connected to a device selected from the group consisting of a well-logging tool; a nuclear medicine apparatus; and an apparatus for detecting the presence of radioactive materials in cargo containers.
